(19) United States
(12) Patent Application Publication
(10) Pub. No.: US 2021/0174285 A1
(43) Pub. Date: Jun. 10, 2021

(54) INFORMATION PROCESSING APPARATUS, INFORMATION PROCESSING METHOD, AND MEDIUM

(71) Applicant: CANON KABUSHIKI KAISHA, Tokyo (JP)

(72) Inventor: Kohei Iwabuchi, Kanagawa (JP)

(21) Appl. No.: 17/180,392

(22) Filed: Feb. 19, 2021

Related U.S. Application Data
(63) Continuation of application No. PCT/JP2019/029920, filed on Jul. 31, 2019.

(30) Foreign Application Priority Data
Aug. 23, 2018 (JP) 2018-156440

(51) Int. Cl. G06Q 10/06; A01B 79/00; G16Y 10/05

(52) U.S. Cl. CPC G06Q 10/06316; A01B 79/005; G16Y 10/05; G06Q 10/063116; G06Q 10/063112

(57) ABSTRACT

There is provided with an information processing apparatus. A resource amount determination unit determines a required resource amount for executing a task to be executed in at least a partial section of an agricultural field in which a crop is grown based on a size of the section in which the task is executed and a state of an object on which the task is executed. An output control unit controls the required resource amount determined by the resource amount determination unit to be displayed in association with the section in which the task is executed on a map representing the agricultural field displayed on a predetermined display unit.

### CROSS-REFERENCE TO RELATED APPLICATIONS

This application is a Continuation of International Patent Application No. PCT/JP2019/029920, filed Jul. 31, 2019, which claims the benefit of Japanese Patent Application No. 2018-156440, filed Aug. 23, 2018, both of which are hereby incorporated by reference herein in their entirety.

### BACKGROUND OF THE INVENTION

### Field of the Invention

The present invention relates to an information processing apparatus, an information processing method, and a medium.

### Description of the Related Art

Heretofore, in an agricultural field, various tasks (works) have been executed depending on crop growing conditions, weather conditions, occurrence of disease or pest, or the like. In particular, in a large agricultural field, a large number of workers are required to deal with a large number of tasks, and an agricultural field manager is positioned to manage the workers. The agricultural field manager allocates the workers to each task generated in the agricultural field, and causes the workers to execute the task. In this case, if an appropriate number of workers cannot be allocated depending on the scale of each task, the task cannot be completed within a predetermined period of time, or some workers will not know what to do during their work time, which causes problems in terms of outcome and cost. Meanwhile, Japanese Patent Laid-Open No. 2013-254356 discusses a technique for estimating the scale of a task based on the area of an agricultural field and calculating a required resource amount for executing the task based on the scale of the task and the unit resource amount corresponding to the scale of the task.

### SUMMARY OF THE INVENTION

According to an embodiment of the present invention, an information processing apparatus comprises one or more processors, wherein the one or more processors function as: a resource amount determination unit configured to determine a required resource amount for executing a task to be executed in at least a partial section of an agricultural field in which a crop is grown based on a size of the section in which the task is executed and a state of an object on which the task is executed; and an output control unit configured to control the required resource amount determined by the resource amount determination unit to be displayed in association with the section in which the task is executed on a map representing the agricultural field displayed on a predetermined display unit.

According to another embodiment of the present invention, an information processing method comprises: determining a required resource amount for executing a task to be executed in at least a partial section of an agricultural field in which a crop is grown based on a size of the section in which the task is executed and a state of an object on which the task is executed; and controlling the determined required resource amount to be displayed in association with the section in which the task is executed on a map representing the agricultural field displayed on a predetermined display unit.

According to still another embodiment of the present invention, a non-transitory computer-readable medium stores a program for causing a computer to perform a method comprising: determining a required resource amount for executing a task to be executed in at least a partial section of an agricultural field in which a crop is grown based on a size of the section in which the task is executed and a state of an object on which the task is executed; and controlling the determined required resource amount to be displayed in association with the section in which the task is executed on a map representing the agricultural field displayed on a predetermined display unit.

Further features of the present invention will become apparent from the following description of exemplary embodiments with reference to the attached drawings.

### BRIEF DESCRIPTION OF THE DRAWINGS

FIG. 1 is a hardware configuration diagram illustrating an information processing apparatus according to a first exemplary embodiment.

FIG. 2 is an explanatory diagram illustrating an agricultural field and blocks.

FIG. 3 is a functional configuration diagram illustrating the information processing apparatus.

FIG. 4 is a table illustrating a data configuration example of a block table.

FIG. 5 is a table illustrating a data configuration example of a crop table.

FIG. 6 is a table illustrating a data configuration example of a work type table.

FIG. 7 is a table illustrating a data configuration example of a task table.

FIG. 8 is a diagram illustrating an example of a crop information input screen.

FIG. 9 is a diagram illustrating an example of a task input screen.

FIG. 10 is a diagram illustrating an example of a display screen.

FIG. 11 is a flowchart illustrating required resource amount management processing.

FIG. 12A is an explanatory diagram illustrating work information coefficients.

FIG. 12B is an explanatory diagram illustrating work information coefficients.

FIG. 13A is an explanatory diagram illustrating work information coefficients.

FIG. 13B is an explanatory diagram illustrating work information coefficients.

FIG. 14A is an explanatory diagram illustrating scattering coefficients.

FIG. 14B is an explanatory diagram illustrating scattering coefficients.

FIG. 15 is a diagram illustrating an example of application to a production field.

FIG. 16 is a table illustrating a data configuration example of a task table.

FIG. 17 is a diagram illustrating an example of a task input screen.

FIG. 18 is a flowchart illustrating required resource amount management processing according to a second exemplary embodiment.

FIG. 19 is a table illustrating a data configuration example of a worker table.

FIG. 20 is a diagram illustrating an example of a task input screen.

FIG. 21A is a table illustrating a data configuration example of a worker table and a skill level table.

FIG. 21B is a table illustrating a data configuration example of a worker table and a skill level table.

FIG. 22 is a table illustrating a data configuration example of a task table.

FIG. 23A is a table illustrating a data configuration example of a cumulative reduction amount table and a cumulative distribution amount table.

FIG. 23B is a table illustrating a data configuration example of a cumulative reduction amount table and a cumulative distribution amount table.

FIG. 24A is a diagram illustrating an example of a display screen.

FIG. 24B is a diagram illustrating an example of a display screen.

FIGS. 25, 25A, and 25B are a flowchart illustrating required resource amount management processing according to a third exemplary embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

According to Japanese Patent Laid-Open No. 2013-254356, information indicating, for example, crop growing conditions or occurrence of disease or pest, which has a great influence on the scale of a task in the actual agricultural field, is not taken into consideration. Thus, the accuracy of the calculated resource amount is not high.

An embodiment of the present invention can make it possible to accurately obtain a required resource amount for executing a task.

### First Exemplary Embodiment

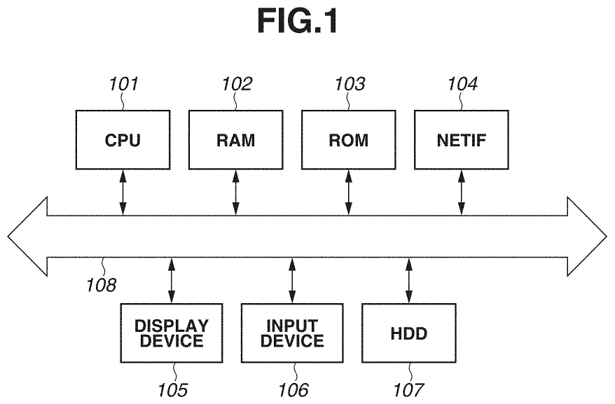

FIG. 1 is a hardware configuration diagram illustrating an information processing apparatus 100 according to a first exemplary embodiment. A central processing unit (hereinafter referred to as a CPU) 101 controls a computer system. The CPU 101 implements each functional configuration and processing to be described below by executing calculation and processing on information and controlling each hardware module based on control programs. A main memory 102 is a random access memory (hereinafter referred to as a RAM), and functions as a work memory for loading an execution program and executing a program as a main memory for the CPU 101. A read-only memory (hereinafter referred to as a ROM) 103 records control programs that provide an operation processing procedure for the CPU 101. The ROM 103 includes a program ROM on which basic software (operating system (OS)) is recorded as a system program for controlling a device for a computer system, and a data ROM on which information required for operating the system and the like are recorded. A hard disk drive (HDD) 107 to be described below may also be used instead of the ROM 103. Functions and processing of the information processing apparatus 100 to be described below are implemented such that the CPU 101 reads out programs stored in the ROM 103 or the HDD 107 and executes the programs.

A network interface (hereinafter referred to as a NETIF) 104 controls input and output of data to be transmitted and received via a network. A display device 105 is, for example, a cathode-ray tube (CRT) display or a liquid crystal display. An input device 106 is used to receive an operation instruction from a user, and is, for example, a touch panel, a keyboard, or a mouse. The HDD 107 is a storage device. The HDD 107 is used to store data such as application programs. An input/output bus (an address bus, a data bus, and a control bus) 108 is used to connect the above-described units.

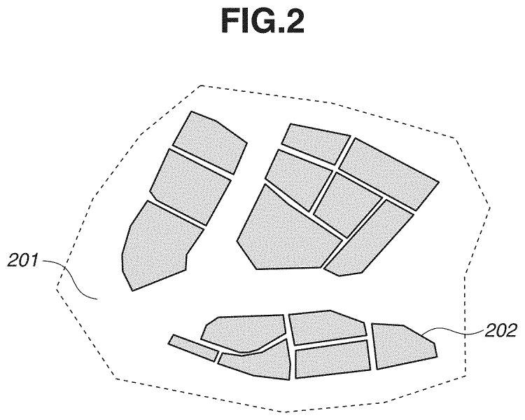

The information processing apparatus 100 according to the present exemplary embodiment manages resources required for tasks such as observation of growing conditions and dealing with disease or pest in an agricultural field. FIG. 2 is an explanatory diagram illustrating an agricultural field and blocks. FIG. 2 illustrates an agricultural field 201 and blocks 202. The agricultural field 201 is divided into a plurality of blocks 202. In the present exemplary embodiment, the agricultural field 201 is divided into the blocks 202 depending on a difference in the breed of crops to be planted, a difference in growing policies, geographical conditions, and the like. In other words, each block 202 is a partial region in an agricultural field that is distinguished from the other blocks depending on the breed of crops to be planted, geographical conditions, and the like. In the present exemplary embodiment, assume that one type of crop is planted in one block.

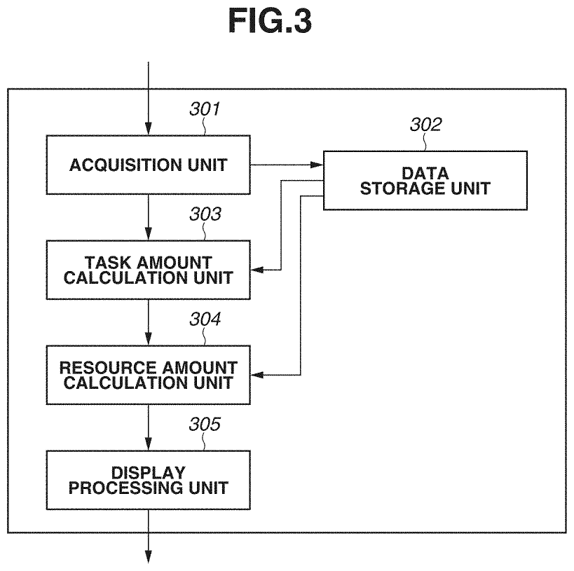

FIG. 3 is a functional configuration diagram illustrating the information processing apparatus 100. The information processing apparatus 100 includes an acquisition unit 301, a data storage unit 302, a task amount calculation unit 303, a resource amount calculation unit 304, and a display processing unit 305. The acquisition unit 301 acquires various kinds of information according to a user operation. The data storage unit 302 stores various kinds of information. The data storage unit 302 stores, for example, a block table, a crop table, a work type table, a task table, and the like. These tables will be described in detail below. The data storage unit 302 is implemented by the HDD 107 or the like.

The task amount calculation unit 303 calculates a task amount. The term “task” used herein refers to a work. The term “task amount” refers to the amount of tasks to be executed. The task amount is calculated depending on the size of a task target range and the state of an object (crop) on which the task is executed. The resource amount calculation unit 304 calculates a required resource amount based on the task amount calculated by the task amount calculation unit 303. The term “required resource amount” used herein refers to the amount of resources required for executing a task. In the present exemplary embodiment, the required resource amount corresponds to the number of workers. The required resource amount is not limited to the number of workers, but instead may be an amount of subjects that execute a task. The display processing unit 305 controls various information to be displayed on the display device 105. The display processing unit 305 performs control such that, for example, the required source amount calculated by the resource amount calculation unit 304 is displayed.

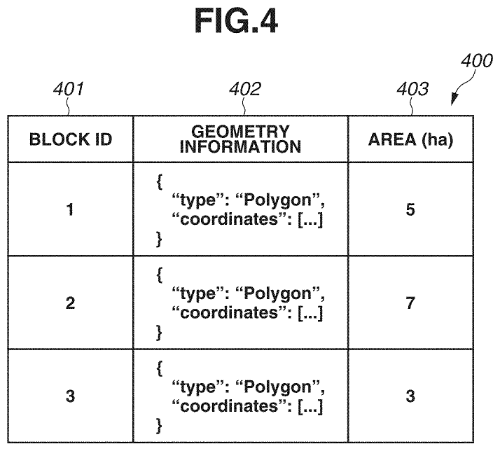

FIG. 4 is a table illustrating a data configuration example of a block table 400. The block table 400 stores a plurality of records for each block. Each record is information including a block ID 401, geometry information 402, and an area 403, which are associated with each other. Each record in the block table 400 is referred to as block information, as needed. The block ID is information for uniquely identifying a block in the block table 400. The geometry information 402 is information indicating an outline of a block. The geometry information only needs to be described in a known format such as Geographic JavaScript Object Notation (GeoJSON). The area 403 is the area of the corresponding block.

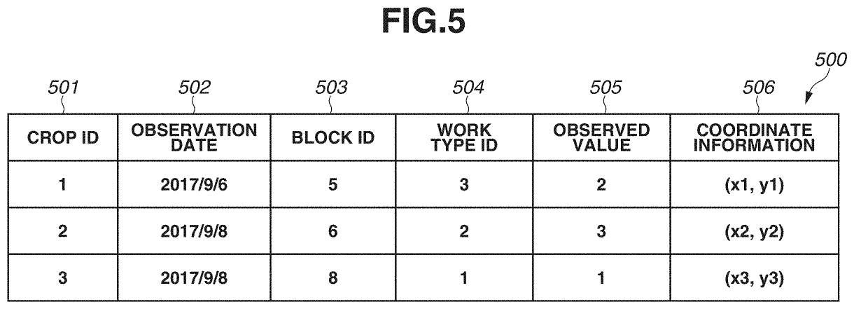

FIG. 5 is a table illustrating a data configuration example of a crop table 500. The crop table 500 stores a plurality of records for each crop. Each record is information including a crop ID 501, an observation date 502, a block ID 503, a work type ID 504, an observed value 505, and coordinate information 506, which are associated with one another. Each record in the crop table 500 is referred to as crop information, as needed. The crop ID 501 is information for uniquely identifying a crop. The observation date 502 is a date and time when the corresponding crop is observed. The block ID 503 is identification information about a block including a crop. The block ID 503 is associated with the corresponding record in the block table 400.

The work type ID 504 is information for identifying the type of a work to be executed on a crop. Examples of the work type include powdery mildew, downy mildew, and observation of growing conditions. A work (task) to be executed to deal with powdery mildew is a work for prevention and treatment of powdery mildew. The observed value 505 is an index value for a crop. The observed value 505 is a value corresponding to a work identified by the work type ID 504. For example, when the work type indicates powdery mildew, the observed value 505 is an index value indicating progression of powdery mildew, and when the work type indicates growing conditions, the observed value 505 is an index value indicating growing conditions.

The coordinate information 506 is information indicating the position of a crop. The coordinate information 506 is represented by geographic coordinates in a geographical coordinate system. In another example, the coordinate information 506 may be represented by relative coordinates with any point in a block as an origin.

Each record in the crop table 500 is information indicating the state of a crop obtained by observing the crop. For example, the record corresponding to the crop ID “1” indicates that the crop belongs to the block corresponding to the crop block ID “5” and the crop is located at coordinates (x1, y1). Further, the record corresponding to the crop ID “1” indicates that the observed value for the work corresponding to the work type ID “3” is “2”.

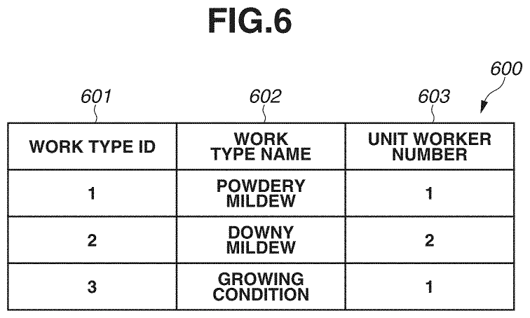

FIG. 6 is a table illustrating a data configuration example of a work type table 600. The work type table 600 stores records for each work type. Each record is information including a work type ID 601, a work type name 602, and a unit worker number 603, which are associated with one another. Each record in the work type table 600 is referred to as work type information, as needed. The work type ID 601 is information for identifying a work type. The work type name 602 is information indicating the name of a work type. The unit worker number 603 indicates the number of workers per unit task amount required for executing each task. In this case, the number of workers corresponds to the resource amount. Assume that a required resource amount per unit task amount is set based on the performance of tasks previously executed.

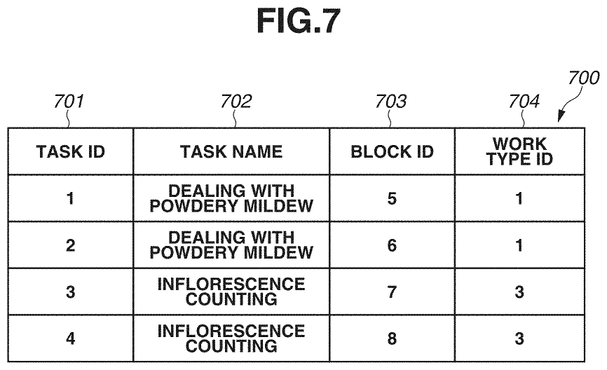

FIG. 7 is a table illustrating a data configuration example of a task table 700. The task table 700 stores records for each task. Each record is information including a task ID 701, a task name 702, a block ID 703, and a work type ID 704, which are associated with one another. The task ID 701 is information for uniquely identifying a task. The task name 702 is a name indicating contents of a task. The block ID 703 is a block ID of a block on which a task is executed. The work type ID 704 is a work type ID of a work to be executed as a task.

The block table 400, the crop table 500, and the work type table 600 are set in advance by a manager or the like and are updated, as needed. On the other hand, a record is added to the task table 700 depending on the input of a task by the user.

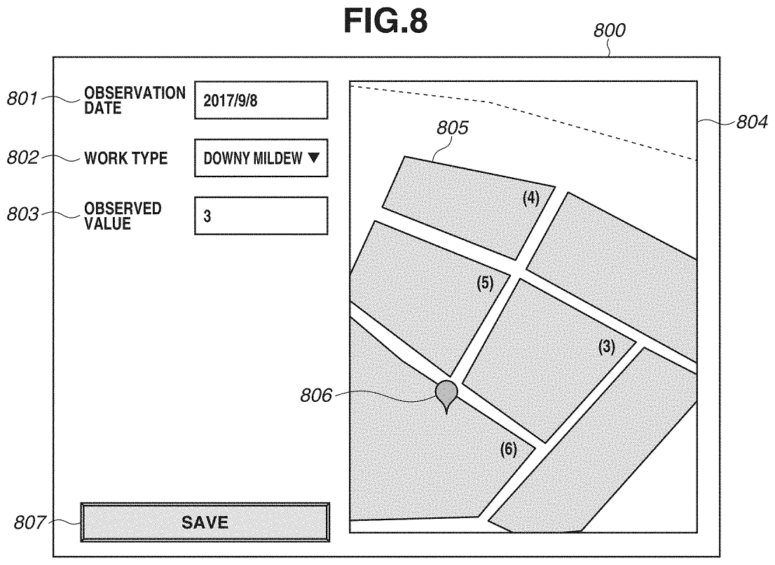

FIG. 8 is a diagram illustrating an example of a crop information input screen 800 on which information obtained through observation of a crop is input. A text field 801 is a text field in which a date and time when a crop is observed is input. For user convenience, an input user interface (UI) for a calendar format or the like may be used. A drop-down list 802 is used to select a crop information type. A text field 803 is a text field in which an observed value for a crop is input. A region 804 is used to designate coordinate information about a crop to be observed and a block to which the crop belongs. When the user designates coordinates in the region 804 by using the input device 106, the CPU 101 searches in the block table 400 using the designated coordinates as a key, and identifies the record for the block including the designated coordinates. A polygon 805 represents a block. In the present exemplary embodiment, a block number is displayed in the region of a block, thereby enabling the user to uniquely identify the block. A marker 806 represents crop information. The marker is displayed at the coordinates designated in the region 804. A button 807 is used to save the input values 801 to 803 and the block ID of the block designated in the region 804 in the HDD 107.

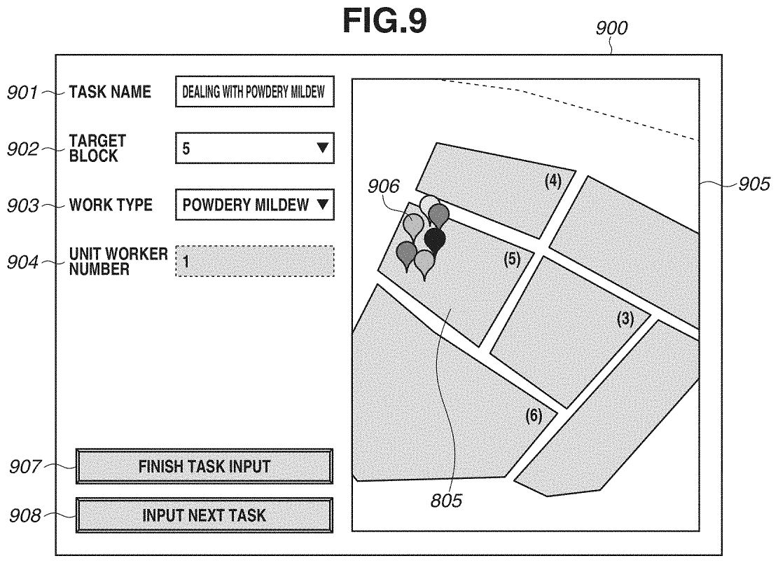

FIG. 9 is a diagram illustrating an example of a task input screen 900 (first screen). A text field 901 is a text field in which a task name is input. A drop-down list 902 is used to select a block on which a task is executed. A drop-down list 903 is used to select a work type. When the user selects a work type in the drop-down list 903, the CPU 101 searches the corresponding record in the work type table 600 using the work type as a key. Depending on the search result, the unit worker number 603 of the searched record is displayed in a unit worker number 904. A region 905 is a region in which the agricultural field, blocks, and a marker representing crop information are displayed on the map. A marker 906 represents crop information. The density of each color of the marker represents the magnitude of the observed value for each crop. The crop information to be displayed on the map as a marker is obtained by searching in the crop table 500 using the work type ID input in the drop-down list 903 as a key.

The marker 906 corresponding to the crop information is displayed in such a manner that the marker 906 is superimposed on the region 905, thereby enabling the user to learn the observed value for a crop on which a task is executed. A button 907 is used to save the input value in the text field 901. The value saved in this case is stored as a record in the task table 700. A button 908 is used to save the input value in the text field 901 and continuously input the next task. A button 908 includes not only the function of the button 907, but also a function for initializing the contents in the fields 901 to 905 and enabling the user to input the next task.

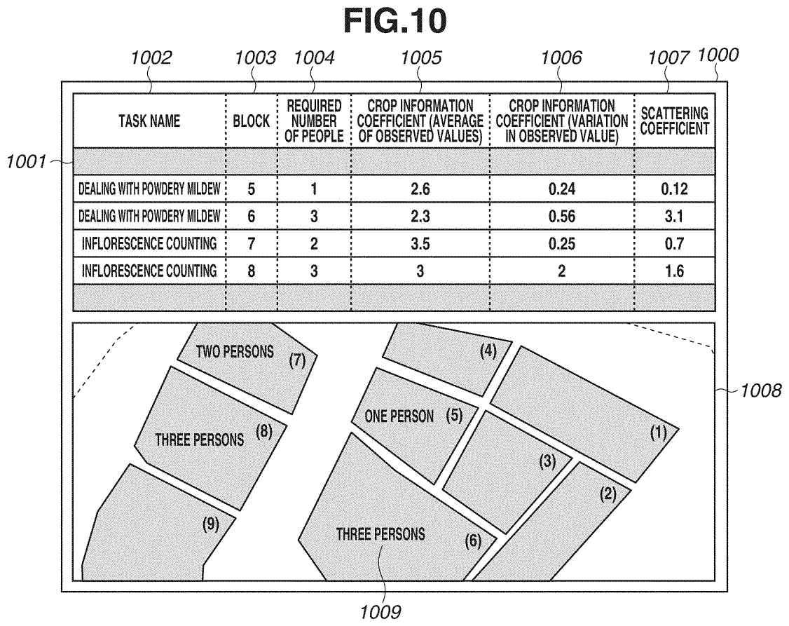

FIG. 10 is a diagram illustrating a display screen 1000 (second screen) indicating the required resource amount. A table 1001 is a table in which the required resource amounts are arranged for each task. An item 1002 indicates a task name. An item 1003 indicates a block ID of a block on which a task is executed. An item 1004 indicates the required resource amount. Coefficients 1005, 1006, and 1007 are used to calculate the required resource amount 1004. The coefficients will be described below. A region 1008 is a region to be displayed in such a manner that the required resource amount is superimposed on the block displayed on the map. A required resource amount 1009 is displayed in such a manner that the required resource amount is superimposed on the block.

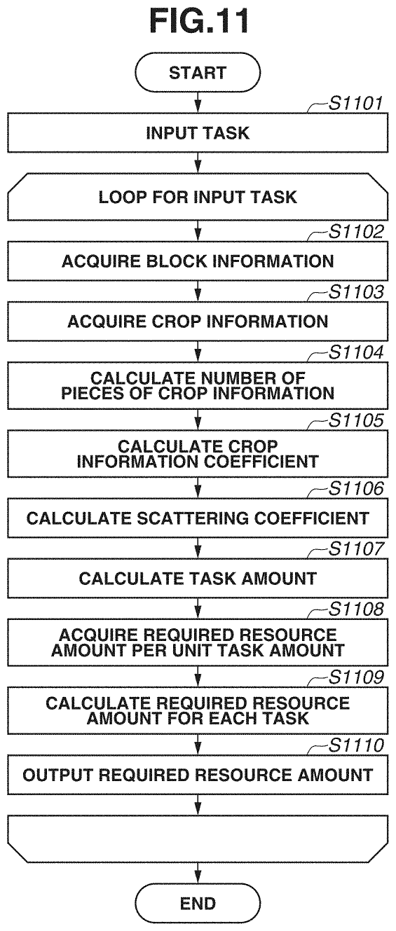

FIG. 11 is a flowchart illustrating required resource amount management processing to be executed by the information processing apparatus 100. In step S1101, the acquisition unit 301 receives an input of one or more tasks. The user inputs information about each task on the task input screen 900 described above with reference to FIG. 9. The acquisition unit 301 stores the acquired task information in the task table 700 (FIG. 7). Next, the CPU 101 repeatedly performs the processing of steps S1102 to S1110 by the number of tasks. The processing of steps S1102 to S1110 is roughly divided into three processes, i.e., calculation of the task amount (steps S1102 to S1107), calculation of the required resource amount (steps S1108 to S1109), and output of the required resource amount (step S1110). The processing of calculating the task amount and the processing of calculating the required resource amount are examples of task amount identifying processing and resource amount determination processing, respectively.

First, the calculation of the task amount (steps S1102 to S1107) will be described. In step S1102, the task amount calculation unit 303 acquires block information corresponding to the block ID 703 in the block table 400 (FIG. 4) using the block ID 703 (FIG. 7) of the input task as a search key. Next, in step S1103, the task amount calculation unit 303 acquires crop information corresponding to the work type ID 704 in the crop table 500 (FIG. 5) using the work type ID 704 of the input task as a search key. If the crop table 500 includes a plurality of pieces of crop information corresponding to the work type ID 704, the plurality of pieces of crop information is acquired. Next, in step S1104, the task amount calculation unit 303 counts the number of pieces of crop information based on which a work is executed in the crop information acquired in step S1103. For example, when the task indicates powdery mildew, crops on which powdery mildew is not detected are not counted. On the other hand, when the task indicates growing conditions, all crops are counted. In this case, the number of pieces of crop information is an index value corresponding to the size of a task target range.

Next, in step S1105, the task amount calculation unit 303 calculates work information coefficients. It is considered that the magnitude of the observed value for each crop and a variation in the observed value may affect the task amount. On the other hand, the task amount calculation unit 303 calculates a first coefficient depending on the magnitude of the observed value for each crop and a second coefficient depending on a variation in the observed value as crop information coefficients.

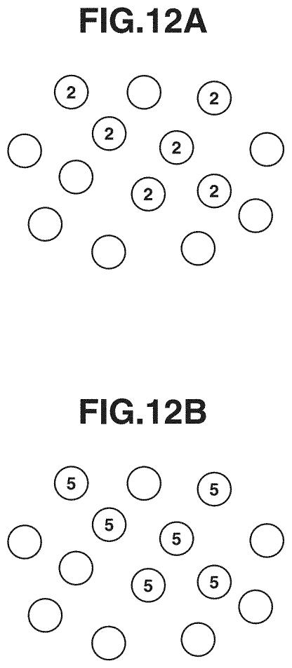

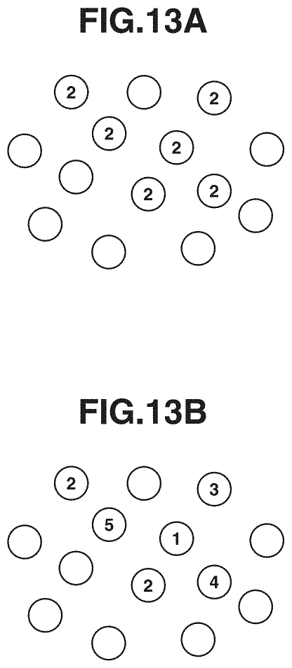

FIGS. 12A to 13B are explanatory diagrams illustrating work information coefficients. Powdery mildew will now be described by way of example. Each white circle represents a healthy crop, and each circle with a number represents a crop with powdery mildew. The number in each circle represents the observed value related to powdery mildew. In the present exemplary embodiment, five numbers of 1 to 5 are displayed. A greater observed value indicates a higher degree of damage. The first coefficient, which is one of the work information coefficients, will now be described with reference to FIGS. 12A and 12B. FIGS. 12A and 12B are diagrams each illustrating crops in the same group. Assume that the position and the number of crops in FIG. 12A are the same as those in FIG. 12B. Also, assume that the position and the number of crops with powdery mildew in FIG. 12A are the same as those in FIG. 12B. However, assume that the observed value for powdery mildew in FIG. 12A is different from that in FIG. 12B. The observed value in FIG. 12A is “2”, and the observed value in FIG. 12B is “5”. The magnitude of the observed value is calculated as the first coefficient.

In the agricultural field, a countermeasure (task) is required depending on the degree of damage. In other words, the type or scale of the countermeasure varies depending on the degree of damage. Assume herein that as the degree of damage increases, the scale of the countermeasure to be taken increases. Accordingly, the task amount in the case of FIG. 12A is set to be larger than that in the case of FIG. 12B, and the task amount calculation unit 303 calculates a value that increases as the observed value increases as a first coefficient aa. In other words, the first coefficient is a coefficient depending on the magnitude of the observed value. The task amount calculation unit 303 obtains the first coefficient aa by Expression (1). In Expression (1), o1, o2, o3, . . . , and on represent observed values for n pieces of crop information. “n” represents the number of pieces of crop information calculated in step S1104. “fa” represents a function for obtaining a representative value of arguments o1, o2, o3, . . . , and on. As the representative value, an average value, a maximum value, or a median can be used.

αa=fa(o1,o2,o3, . . . ,on) (1)

In another example, the task amount calculation unit 303 may obtain the first coefficient aa with reference to the table in which the degree of damage is associated with the first coefficient aa. In still another example, the task amount calculation unit 303 may obtain the first coefficient aa using a function with which the first coefficient aa decreases as the degree of damage increases, which is opposite to that described above. This is suitable when the degree of damage is extremely large and thus the crop should be discarded.

Next, the second coefficient will be described with reference to FIGS. 13A and 13B. FIGS. 13A and 13B are diagrams each illustrating crops in the same group. Assume that the position and the number of crops in FIG. 13A are the same as those in FIG. 13B. Also, assume that the position and the number of crops with powdery mildew in FIG. 13A are the same as those in FIG. 13B. However, assume that the observed value for powdery mildew in FIG. 13A is different from that in FIG. 13B. All observed values for crops with powdery mildew in FIG. 13A are “2”, while the observed values for crops with powdery mildew in FIG. 13B are different. Like in the example illustrated in FIG. 13B, as the degree of damage varies, the number of types of the countermeasure increases. In addition, an overhead for switching the countermeasure during execution of a task increases. Accordingly, the task amount increases as a variation in the observed value increases.

Accordingly, the task amount calculation unit 303 calculates a value that increases as a variation in the observed value increases as a second coefficient αv. That is, the second coefficient αv is a coefficient indicating a statistic representing a variation. Specifically, the task amount calculation unit 303 calculates the second coefficient αv by Expression (2). In Expression (2), fv represents a function for obtaining a statistic representing a variation in the arguments o1, o2, o3, . . . , and on. Specifically, the function fv only needs to be any function for obtaining a statistic of a dispersion, a standard deviation, or the like.

αv=fv(o1,o2,o3, . . . ,on) (2)

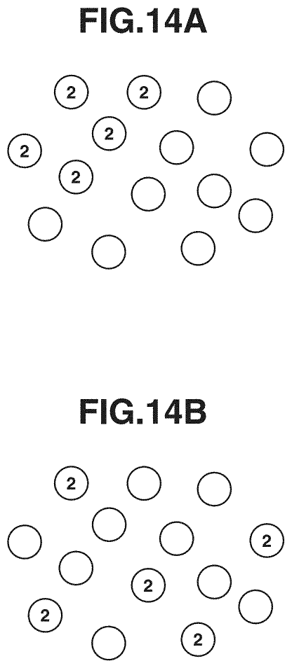

Referring again to FIG. 11, after the calculation of the work information coefficients, in step S1106, the task amount calculation unit 303 calculates a scattering coefficient. In this case, the scattering coefficient represents the magnitude of the influence of a geographical variation in crops on the scale of each work as a coefficient. The scattering coefficient will be described with reference to FIGS. 14A and 14B. FIGS. 14A and 14B each illustrate crops in the same group. The number of crops with powdery mildew and the observed values in FIG. 14A are the same as those in FIG. 14B, and the position of each crop with powdery mildew in FIG. 14A is different from that in FIG. 14B. In the example illustrated in FIG. 14A, crops with powdery mildew aggregate at one location, while in the example illustrated in FIG. 14B, crops with powdery mildew are scattered over the group. As illustrated in FIG. 14A, in a case where the crops aggregate at one location, each worker can reach all the crops with powdery mildew with a minimum movement. On the other hand, in a case where the crops with powdery mildew are scattered as illustrated in FIG. 14B, the amount of movement of each worker is larger than that in FIG. 14A. The task amount increases as the amount of movement increases.

Accordingly, the task amount calculation unit 303 calculates, as a third coefficient βv, a value that increases as the range in which the crops with powdery mildew are present increases. That is, the third coefficient βv is a coefficient depending on the size of the range in which the crops for which a work is required are present. Specifically, the task amount calculation unit 303 obtains the third coefficient βv by Expression (3).

βv=g(p1,p2,p3, . . . ,pn) (3)

In Expression (3), p1, p2, p3, . . . , and pn represent crop coordinate vectors. “g” represents a function for obtaining a statistic representing a geographical variation in the arguments p1, p2, p3, . . . , and pn. Expression (4) can be used to calculate the function g (p1, p2, p3, . . . , pn). In this case, “c” represents a gravitational center of each of crop coordinate vectors p1, p2, p3, . . . , and pn.

$$g ( {p}_{1} , {p}_{2} , {p}_{3} , … , {p}_{n} ) = \frac{1}{n} {\sum }_{i = 0}^{n} \vert {p}_{i} - C \vert \qquad ( 4 )$$

Referring again to FIG. 11, after the calculation of the scattering coefficient, in step S1107, the task amount calculation unit 303 calculates a task amount. Specifically, the task amount calculation unit 303 calculates a task amount St by Expression (5). “Sb” represents the number of pieces of crop information.

St=Sb*aa*av*βv (5)

Thus, the calculation of the task amount (steps S1102 to S1107) is completed. Next, the resource amount calculation unit 304 calculates the required resource amount. Specifically, in step S1108, the resource amount calculation unit 304 obtains work type information associated with the work type ID 704 in the work type table 600 using the work type ID 704 corresponding to the input task as a search key. The unit worker number 603 of the obtained work type information is acquired as the required resource amount per unit task amount.

Next, in step S1109, the resource amount calculation unit 304 calculates a required resource amount Rt for the input task by Expression (6) based on the task amount St and a required resource amount Ru per unit task amount. In this case, the task amount St corresponds to the value calculated in step S1107, and the required resource amount Ru per unit task amount corresponds to the value acquired in step S1108.

Rt=St*Ru (6)

In step S1110, the display processing unit 305 controls the required resource amount calculated in step S1109 to be displayed on the display device 105. Specifically, the display processing unit 305 controls the display screen 1000 indicating the required resource amount to be displayed.

As described above, the information processing apparatus 100 according to the present exemplary embodiment can determine the required resource amount for executing each task based on the size of the task target range and the state of the object, and can output the required resource amount. Thus, the information processing apparatus 100 can accurately obtain the resource amount required for executing each task.

As a first modified example, in a case where a plurality of tasks is input, the resource amount calculation unit 304 may calculate a statistic, such as a total value of the required resource amount for all tasks, based on the required resource amount for each task. Further, the display processing unit 305 may display the statistic together with the required resource amount for each task.

As a second modified example, the destination to which the required resource amount is output is not limited to the display device 105. In another example, the information processing apparatus 100 may output the required resource amount to an external apparatus.

A third modified example will be described. In the present exemplary embodiment, the information processing apparatus 100 uses the number of pieces of crop information as an index for the task execution range in the calculation of the task amount, but instead may use an area in which crop information is distributed. In this case, the information processing apparatus 100 may obtain the area by calculating a convex hull based on the coordinate information 506 about the crop information.

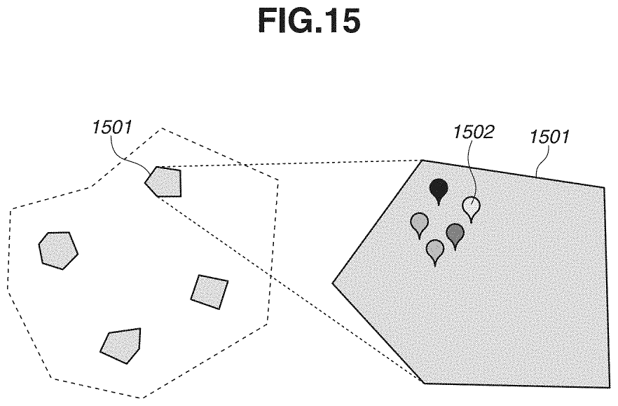

A fourth modified example will be described. While the present exemplary embodiment illustrates an example where the calculation of the required resource amount is applied to an agricultural field, the application field is not limited to agriculture. An example where the calculation of the required resource amount is applied to a maintenance work for a manufacturing device (product) in a manufacturing field will be described with reference to FIG. 15. FIG. 15 illustrates a manufacturing base 1501. The manufacturing base 1501 corresponds to each block 202 in the present exemplary embodiment. FIG. 15 also illustrates a manufacturing device 1502. The manufacturing device 1502 corresponds to each crop in the present exemplary embodiment. The crop information is input through observation of the crop, and similarly, manufacturing device information is input by monitoring the manufacturing device. When the user inputs a task, the required resource amount for executing the task is calculated by required resource amount management processing. The concepts and calculation methods of the crop information coefficient and the scattering coefficient can be applied by replacing a crop with a manufacturing device.

### Second Exemplary Embodiment

In a case where a target completion date/time for a task is set, the information processing apparatus 100 according to a second exemplary embodiment calculates the required resource amount for completing the task on or before the target completion date/time for the task. Differences between the information processing apparatus 100 according to the second exemplary embodiment and the information processing apparatus 100 according to the first exemplary embodiment will be mainly described below.

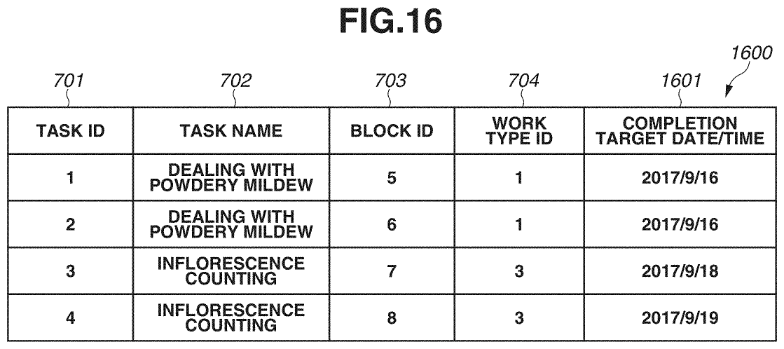

FIG. 16 is a table illustrating a data configuration example of a task table 1600 according to the second exemplary embodiment. The task table 1600 is substantially the same as the task table 700 described above in the first exemplary embodiment with reference to FIG. 7. However, in each record of the task table 1600, a target completion date/time 1601 is further associated with the task ID 701.

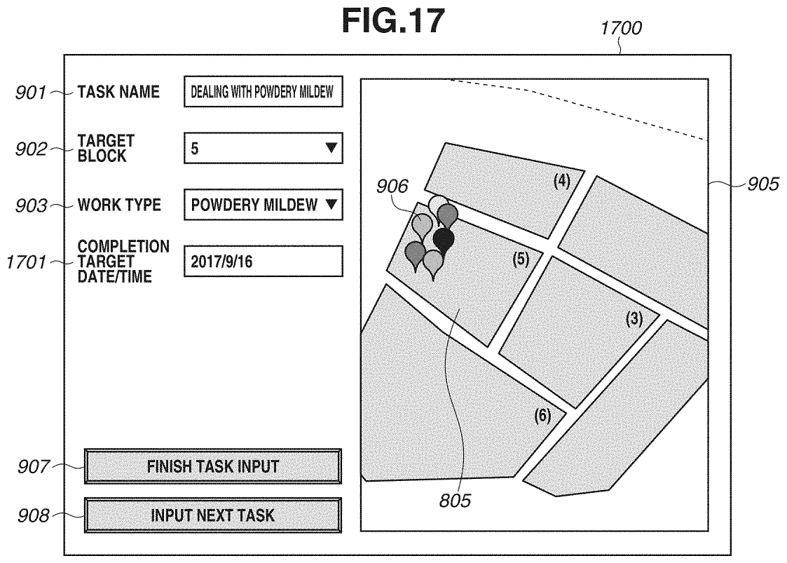

FIG. 17 is a diagram illustrating an example of a task input screen 1700. The task input screen 1700 includes not only the configuration of the task input screen 900 according to the first exemplary embodiment described above with reference to FIG. 9, but also a text field 1701 for inputting the target completion date/time. For user convenience, an input UI for a calendar format may be used.

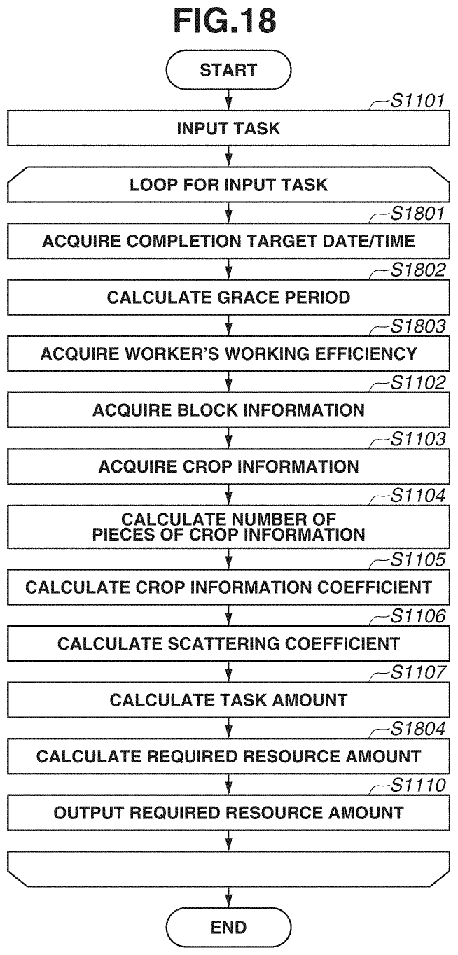

FIG. 18 is a flowchart illustrating required resource amount management processing to be executed by the information processing apparatus 100 according to the second exemplary embodiment. In the processes illustrated in FIG. 18, the processes that are the same as those in the required resource amount management processing according to the first exemplary embodiment described above with reference to FIG. 11 are denoted by the same step number. In the present exemplary embodiment, after receiving an input of a task, the CPU 101 repeats a series of processing (steps S1801 to S1803, steps S1102 to S1107, step S1804, and step S1110) by the number of tasks.

In step S1801, the acquisition unit 301 acquires the target completion date/time 1601 from the input task. Next, in step S1802, the task amount calculation unit 303 calculates a grace period. The term “grace period” used herein refers to a period from a date/time when processing is executed to the target completion date/time. The grace period corresponds to a task execution period. The task amount calculation unit 303 calculates a grace period Te by Expression (7). In Expression (7), Td represents the target completion date/time and Tc represents the date/time when processing is executed.

Te=Td−Tc (7)

Next, in step S1803, the task amount calculation unit 303 acquires a working efficiency. Assume that the working efficiency is set in advance in the information processing apparatus 100. In this case, the working efficiency corresponds to the amount of tasks that can be executed by a worker per hour. In the present exemplary embodiment, assume that the working efficiency is constant regardless of the worker. After the processing of step S1803, the CPU 101 proceeds the processing to step S1102. After the processing of steps S1102 to S1107, the CPU 101 proceeds the processing to step S1804. In step S1804, the task amount calculation unit 303 calculates the required resource amount Rt by Expression (8) based on the task amount St, the grace period Te, and a working efficiency E. After the processing of step S1804, the CPU 101 proceeds the processing to step S1110.

Rt=St/(Te*E) (8)

The other configuration and processing of the information processing apparatus 100 according to the second exemplary embodiment are similar to the configuration and processing of the information processing apparatus 100 according to the first exemplary embodiment. As described above, the information processing apparatus 100 according to the second exemplary embodiment can calculate the required resource amount for completing a task on or before the target completion date/time.

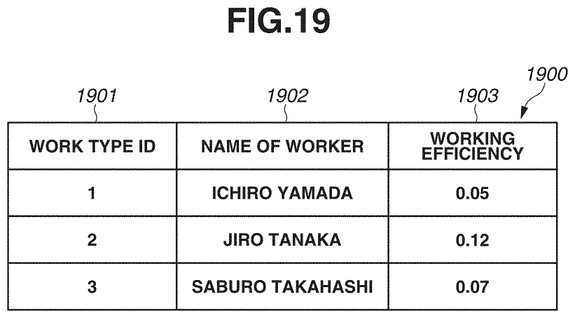

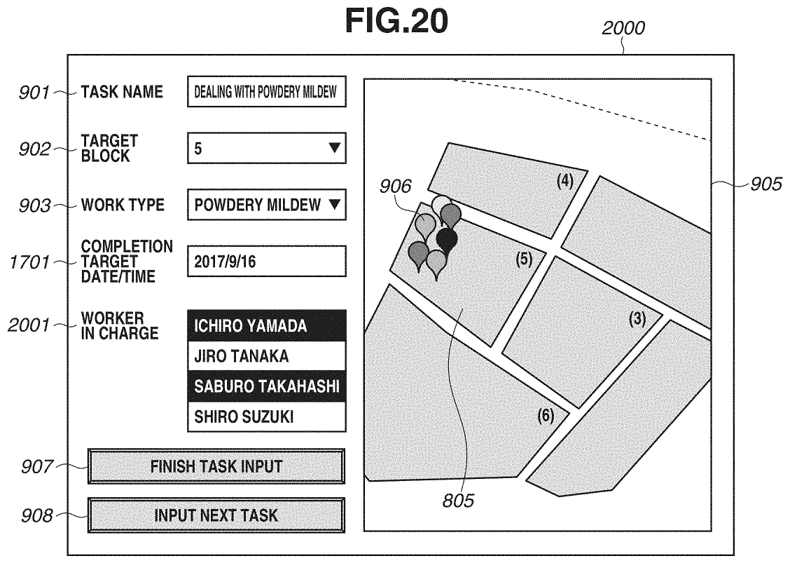

A modified example of the second exemplary embodiment will be described. The information processing apparatus 100 may manage different working efficiencies for each worker. FIG. 19 is a table illustrating a data configuration example of a working efficiency table 1900. The working efficiency table 1900 stores records for each worker. Each record includes a worker ID 1901, a worker name 1902, and a working efficiency 1903, which are associated with one another. FIG. 20 is a diagram illustrating an example of a task input screen 2000. The task input screen 2000 includes not only the configuration of the task input screen 1700 according to the second exemplary embodiment described above with reference to FIG. 17, but also a select box 2001 for selecting a worker. In the select box 2001, a list of workers stored in the working efficiency table 1900 is displayed. The user can select one or more workers from the select box 2001. Further, in step S1803, the task amount calculation unit 303 acquires the working efficiency 1903 associated with the worker selected by the user in the working efficiency table 1900.

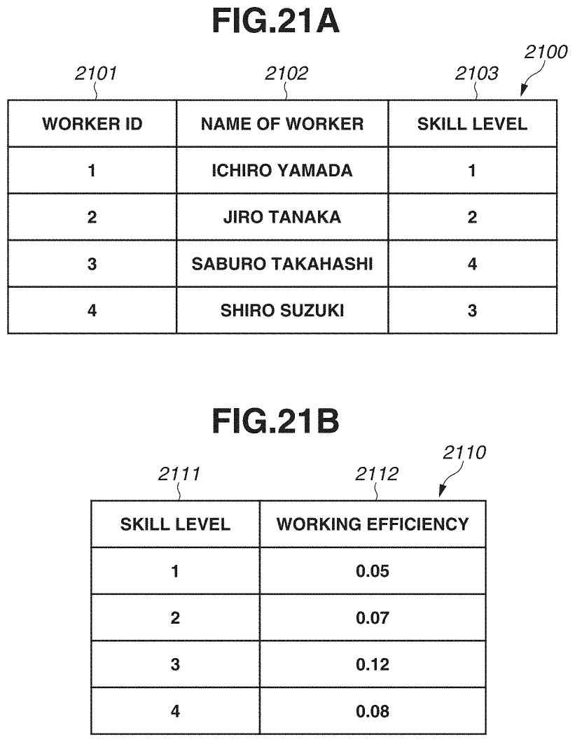

In still another example, the information processing apparatus 100 may store a worker table 2100 illustrated in FIG. 21A and a skill level table 2110 illustrated in FIG. 21B. The worker table 2100 stores records for each worker. Each record includes a worker ID 2101, a worker name 2102, and a skill level 2103, which are associated with one another. The skill level table 2110 stores records for each skill level. Records for each skill level are information in which a skill level 2111 and a working efficiency 2112 are associated with each other. In this case, the task amount calculation unit 303 identifies the skill level 2103 corresponding to the worker selected by the user in the worker table 2100. Further, the task amount calculation unit 303 may acquire the working efficiency 2112 corresponding to the skill level 2103 in the skill level table 2110.

### Third Exemplary Embodiment

The information processing apparatus 100 according to a third exemplary embodiment adjusts the required resource amount so as not to exceed an upper limit when the upper limit of an available resource amount is determined. When the calculated required resource amount is lower than the upper limit, the information processing apparatus 100 according to the third exemplary embodiment distributes a surplus resource to other tasks.

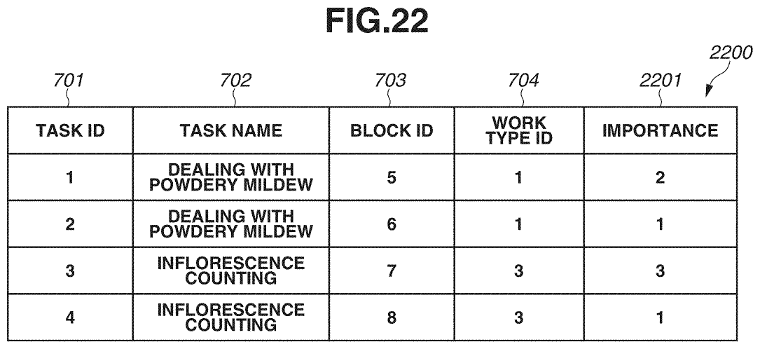

FIG. 22 is a table illustrating a data configuration example of a task table 2200 according to the third exemplary embodiment. The task table 2200 is substantially the same as the task table 700 described above with reference to FIG. 7 in the first exemplary embodiment. However, in each record of the task table 2200, an importance 2201 is further associated with the task ID 701. The importance 2201 is an index indicating which task is selected as a reduction target in the case of reducing an excess resource amount from the required resource amount allocated to each task when a resource total amount exceeds an upper limit resource amount. Tasks for which the resource amount is reduced are selected in ascending order of importance. The importance 2201 is also used as an index indicating which task is preferentially executed in the case of distributing a surplus resource amount to the required resource amount allocated to each task when the resource total amount is less than the upper limit resource amount. Tasks to which resources are distributed are selected in descending order of importance.

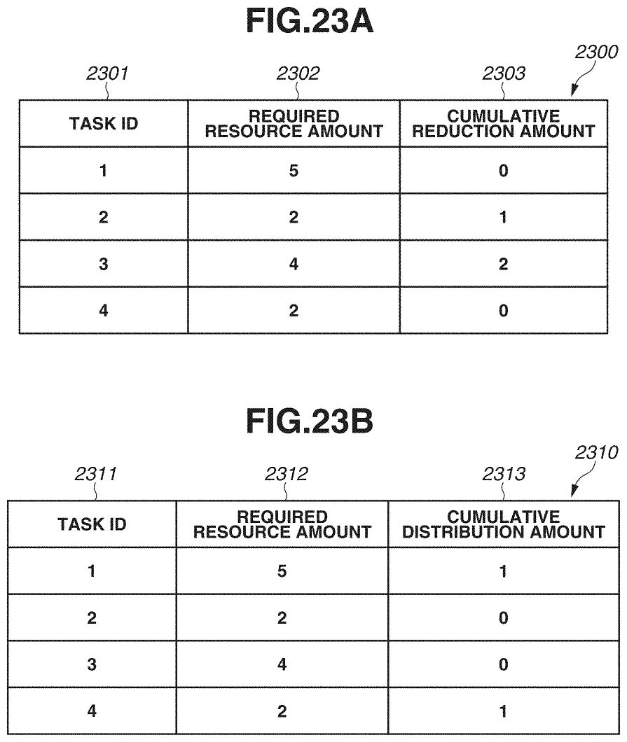

FIG. 23A is a table illustrating a data configuration example of a cumulative reduction amount table 2300. The cumulative reduction amount table 2300 is a table storing temporary data used for excess resource amount adjustment processing to be described below. Each record in the cumulative reduction amount table 2300 is information including a task ID 2301, a required resource amount 2302, and a cumulative reduction amount 2303, which are associated with one another. The required resource amount 2302 is the required resource amount for the corresponding task. The cumulative reduction amount 2303 is the amount of resources to be subtracted from the required resource amount 2302 and is a value set by adjustment processing.

FIG. 23B is a table illustrating a data configuration example of a cumulative distribution amount table 2310. The cumulative distribution amount table 2310 is a table that stores temporary data used for surplus resource adjustment processing to be described below. The record of the cumulative distribution amount table 2310 is information including a task ID 2311, a required resource amount 2312, and a cumulative distribution amount 2313, which are associated with one another. The cumulative distribution amount 2313 is the amount of resources to be added to the required resource amount 2312 and is a value set by adjustment processing.

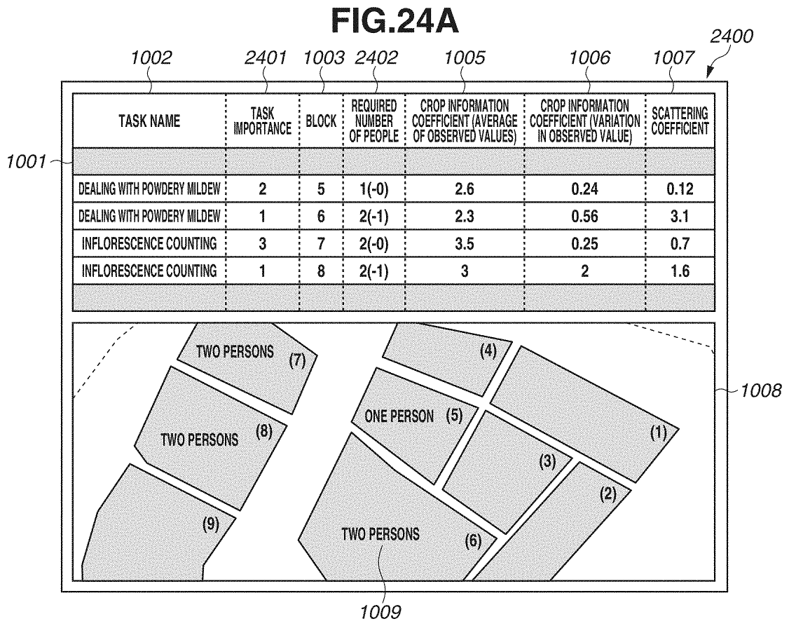

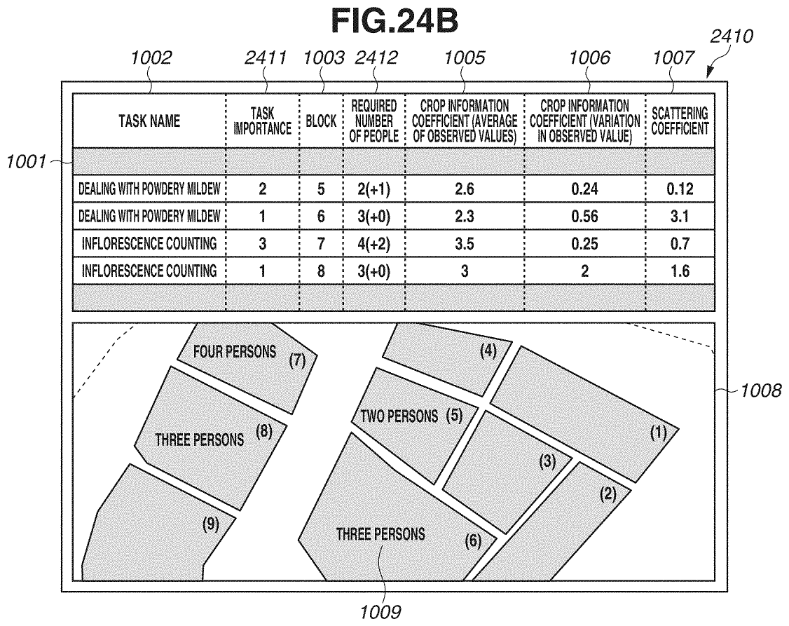

FIGS. 24A and 24B are diagrams illustrating display screens 2400 and 2410, respectively, which indicate the required resource amount. The display screens 2400 and 2410 illustrated in FIGS. 24A and 24B, respectively, correspond to the display screen 1000 described above in the first exemplary embodiment with reference to FIG. 10. The display screen 2400 illustrated in FIG. 24A is a screen to be displayed when the required resource amount is reduced in the adjustment processing. An item 2401 indicates an importance of a task. An item 2402 indicates the required resource amount (required number of people). The required resource amount 2402 is a value obtained after the resource adjustment processing is executed. A value in brackets indicates a reduced resource amount. The display screen 2410 illustrated in FIG. 24B is a screen to be displayed when the required resource amount is distributed in the adjustment processing. An item 2411 indicates an importance of a task. An item 2412 indicates the required resource amount (required number of people). The required resource amount 2412 is a value obtained after the resource adjustment processing is executed. A value in brackets indicates a distributed resource amount.

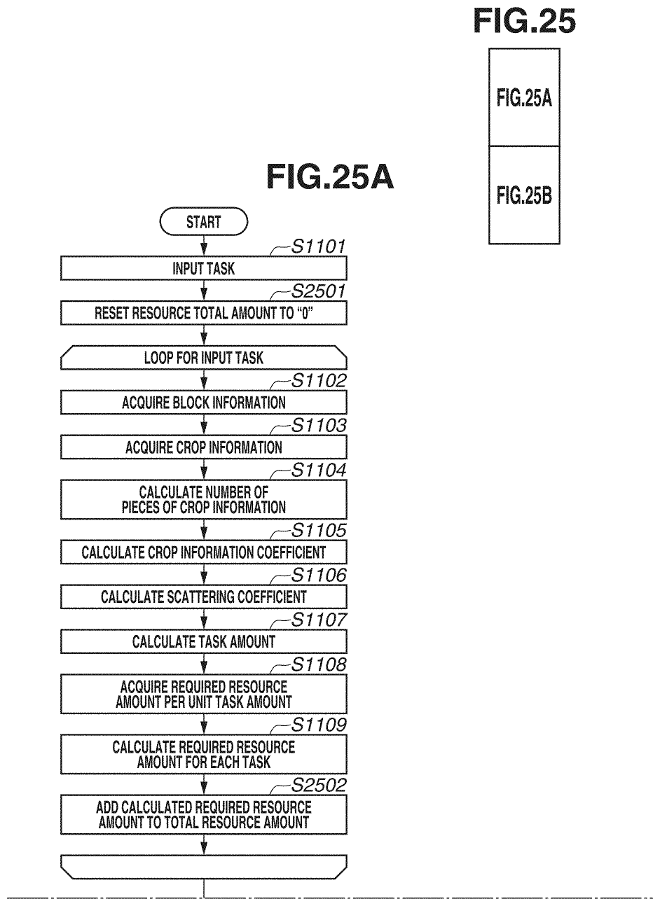

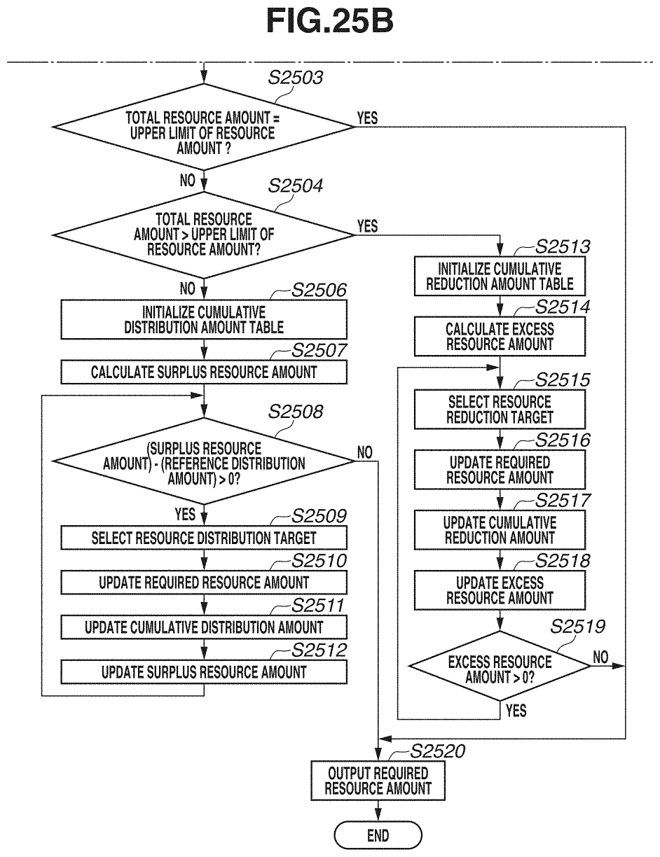

FIGS. 25A and 25B are a flowchart illustrating required resource amount management processing to be executed by the information processing apparatus 100 according to the third exemplary embodiment. In the processes illustrated in FIG. 18, the processes that are the same as those in the required resource amount management processing according to the first exemplary embodiment described above with reference to FIG. 11 are denoted by the same step number. In the present exemplary embodiment, after the processing of step S1101, the CPU 101 proceeds the processing to step S2501. In step S2501, the resource amount calculation unit 304 resets the resource total amount to “0”. In this case, the resource total amount is a total value of the required resource amount allocated to each task. The resource total value is managed as temporary data. After the processing of step S2501, the CPU 101 repeats a series of processing (steps S1102 to S1109 and step S2502) by the number of tasks.

After the processing of step S1109, in step S2502, the resource amount calculation unit 304 adds the required resource amount calculated in step S1109 to the resource total value. After completion of the series of processing, the CPU 101 proceeds the processing to step S2503. In step S2503, the resource amount calculation unit 304 compares the resource total amount with the upper limit resource amount. In this case, the upper limit resource amount is a value set in advance. When the resource total amount is equal to the upper limit resource amount (YES in step S2503), the resource amount calculation unit 304 proceeds the processing to step S2520. When the resource total amount is more than the upper limit resource amount (NO in step S2503 and YES in step S2504), the resource amount calculation unit 304 proceeds the processing to step S2513. When the resource total amount is less than or equal to the upper limit resource amount (NO in step S2503 and NO in step S2504), the resource amount calculation unit 304 proceeds the processing to step S2506.

The processing of steps S2506 to S2512 is processing to be executed when the resource total amount is less than or equal to the upper limit resource amount, and processing to be executed when a surplus resource amount is distributed to each task. In step S2506, the resource amount calculation unit 304 initializes the cumulative distribution amount table 2310. Specifically, the resource amount calculation unit 304 stores “0” in the task ID of the task input in the task ID 2311, the required resource amount allocated to the task input in the required resource amount 2312, and the cumulative distribution amount 2313.

Next, in step S2507, the resource amount calculation unit 304 obtains a surplus resource amount by subtracting the upper limit resource amount from the resource total amount. Next, in step S2508, the resource amount calculation unit 304 compares “0” with the value obtained by subtracting the reference distribution amount from the surplus resource amount. In this case, the reference distribution amount is a unit for distributing the required resource amount allocated to each task and is a value set in advance. In the present exemplary embodiment, assume that the reference distribution amount is “1”. In the present exemplary embodiment, assume that the same reference distribution amount is set for all tasks. In another example, the reference distribution amount may be determined depending on the importance. The information processing apparatus 100 may obtain the reference distribution amount based on the importance, for example, by using a function or a correspondence table. When the value obtained by subtracting the reference reduction amount from the surplus resource amount is greater than “0” (YES in step S2508), the resource amount calculation unit 304 proceeds the processing to step S2509. When the value obtained by subtracting the reference reduction amount from the surplus resource amount is less than or equal to “0” (NO in step S2508), the resource amount calculation unit 304 proceeds the processing to step S2520.

In step S2509, the resource amount calculation unit 304 refers to the task table 2200 (FIG. 22), and selects the task with a highest importance as the resource distribution target. If there is a plurality of tasks with the highest importance, the resource amount calculation unit 304 only needs to select any one of the tasks with the highest importance as the resource distribution target. This processing is an example of task selection processing. Next, in step S2510, the resource amount calculation unit 304 identifies the record corresponding to the resource distribution target task in the cumulative distribution amount table 2310 (FIG. 23B). Further, the resource amount calculation unit 304 updates the required resource amount 2312 in the identified record. Specifically, the reference distribution amount “1” is added to the required resource amount 2312.

Next, in step S2511, the resource amount calculation unit 304 updates the cumulative distribution amount 2313 in the record identified in step S2510. Specifically, the resource amount calculation unit 304 adds the reference distribution amount “1” to the cumulative distribution amount 2313. Next, in step S2512, the resource amount calculation unit 304 updates the surplus resource amount. Specifically, the resource amount calculation unit 304 substrates the reference distribution amount “1” from the surplus resource amount. After that, the CPU 101 proceeds the processing after the processing of step S2512 to step S2508.

On the other hand, the processing of steps S2513 to S2519 is processing to be executed when the resource total amount is more than the upper limit resource amount, and is processing for reducing the resource amount. In step S2513, the resource amount calculation unit 304 initializes the cumulative reduction amount table 2300. Specifically, the resource amount calculation unit 304 stores “0” in the task ID of the task input in the task ID 2301, the required resource amount allocated to the task input in the required resource amount 2302, and the cumulative reduction amount 2303.

Next, in step S2514, the resource amount calculation unit 304 obtains an excess resource amount by subtracting the resource total amount from the upper limit resource amount. Next, in step S2515, the resource amount calculation unit 304 selects the task with the lowest importance 2201 as the resource reduction target with reference to the task table 2200 (FIG. 22). If there is a plurality of tasks with the lowest importance, the resource amount calculation unit 304 may select any one of the tasks with the lowest importance as the resource reduction target. This processing is an example of task selection processing.

Next, in step S2516, the resource amount calculation unit 304 identifies the record corresponding to the task for which the amount of resources is reduced in the cumulative reduction amount table 2300 (FIG. 23A). Further, the resource amount calculation unit 304 updates the required resource amount 2302 in the identified record. Specifically, the resource amount calculation unit 304 subtracts the reference reduction amount from the required resource amount 2302. In this case, the reference reduction amount is a unit for reducing the required resource amount allocated to each task and is a value set in advance. In the present exemplary embodiment, assume that the reference reduction amount is “1”. In the present exemplary embodiment, the same reference reduction amount is set for all tasks. In another example, the reference reduction amount may be determined depending on the importance. The information processing apparatus 100 may obtain the reference reduction amount based on the importance, for example, by using a function or a correspondence table.

Next, in step S2517, the resource amount calculation unit 304 updates the cumulative reduction amount 2303 in the record of the cumulative reduction amount table 2300 identified in step S2516. Specifically, the resource amount calculation unit 304 adds the reference reduction amount “1” to the cumulative reduction amount 2303. Next, in step S2518, the resource amount calculation unit 304 updates the excess resource amount. Specifically, the resource amount calculation unit 304 subtracts the reference reduction amount “1” from the excess resource amount. Next, in step S2519, the resource amount calculation unit 304 compares the excess resource amount with “0”. When the excess resource amount is more than “0” (YES in step S2519), the resource amount calculation unit 304 proceeds the processing to step S2515. When the excess resource amount is less than or equal to “0” (NO in step S2519), the resource amount calculation unit 304 proceeds the processing to step S2520. In step S2520, the display processing unit 305 controls the required resource amount allocated to each task to be displayed on the display device 105. Specifically, the display processing unit 305 performs control such that one of the display screen 2400 and the display screen 2410 indicating the required resource amount is displayed. The other configuration and processing of the information processing apparatus 100 according to the third exemplary embodiment are similar to the configuration and processing of the information processing apparatuses according to other exemplary embodiments.

As described above, when the total amount of the required resource amount allocated to each task exceeds the upper limit resource amount, the information processing apparatus 100 according to the present exemplary embodiment reduces an excess resource amount from the amount of resources allocated to each task. On the contrary, when the total amount of the required resource amount allocated to each task is less than the upper limit resource amount, the information processing apparatus 100 distributes the surplus resource amount to each task. Thus, when the amount of available resources is small with respect to the number of tasks, the limited resources can be effectively allocated to each task. On the contrary, when the amount of available resources is large with respect to the number of tasks, the surplus resource amount can be effectively used.

While exemplary embodiments of the present invention have been described in detail above, the present invention is not limited to the specific exemplary embodiments. The present invention can be modified or changed in various ways within the gist of the present invention described in the scope of claims.

### Other Exemplary Embodiments

While the exemplary embodiments have been described in detail above, the present invention can be applied to, for example, a system, an apparatus, a method, a program, or a recording medium (storage medium), as exemplary embodiments. Specifically, the present invention can be applied to a system composed of a plurality of devices (e.g., a host computer, an interface device, an image capturing device, and a web application), or an apparatus composed of one device.

Needless to say, an object of the present invention can be achieved by the following configuration. That is, a recording medium (or a storage medium) recording a program code (computer program) of software for implementing the functions according to the exemplary embodiments described above is supplied to a system or apparatus. Needless to say, the storage medium is a computer-readable recording medium. A computer (or a CPU or a micro processing unit (MPU)) of the system or apparatus reads out and executes the program code stored in the recording medium. In this case, the program code read out from the recording medium implements the functions according to the exemplary embodiments described above, and the recording medium recording the program code constitutes the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising one or more processors, wherein the one or more processors function as:
a resource amount determination unit configured to determine a required resource amount for executing a task to be executed in at least a partial section of an agricultural field in which a crop is grown based on a size of the section in which the task is executed and a state of an object on which the task is executed; and
an output control unit configured to control the required resource amount determined by the resource amount determination unit to be displayed in association with the section in which the task is executed on a map representing the agricultural field displayed on a predetermined display unit.

2. The information processing apparatus according to claim 1, wherein the task is a work for dealing with at least one of a change in crop growing condition, a change in weather condition, or occurrence of disease or pest in the agricultural field.

3. The information processing apparatus according to claim 1, wherein the output control unit is further configured to display the map and information based on which the required resource amount is calculated by the resource amount determination unit.

4. The information processing apparatus according to claim 1, wherein the one or more processors further function as a task amount identifying unit configured to identify a required task amount for executing the task based on the size of the section in which the task is executed and the state of the object,
wherein the resource amount determination unit is further configured to determine the required resource amount based on the task amount and a required resource amount per unit task amount set in advance.

5. The information processing apparatus according to claim 4, wherein the task amount identifying unit is further configured to identify the task amount based on a geographical position of each of a plurality of objects.

6. The information processing apparatus according to claim 4, wherein the task amount identifying unit is further configured to identify the task amount based on a state of each of a plurality of objects.

7. The information processing apparatus according to claim 4, wherein the task amount identifying unit is configured to identify the task amount further based on a task execution period.

8. The information processing apparatus according to claim 1, wherein the one or more processors further function as:
a reception unit configured to receive an input of task designation information including information indicating a type of the task and the section in which the task is executed; and
an acquisition unit configured to acquire observation data on an item related to the received task designation information from a storage unit storing observation data on a plurality of items related to a state of an object in the section,
wherein the resource amount determination unit is further configured determine a required resource amount for executing the task based on the acquired observation data.

9. The information processing apparatus according to claim 8,
wherein the observation data includes at least information indicating any one of the plurality of items, a value indicating an observation result, and information indicating a position of an observed object, and
wherein the resource amount determination unit is further configured to determine the required resource amount based on a magnitude of the value, a variation in the value, and a spatial variation in observation data indicating a specific state.

10. The information processing apparatus according to claim 9, wherein the output control unit is further configured to display the map and information indicating an average of the value, a variation in the value, and a spatial variation in observation data indicating a specific state as information based on which the required resource amount is calculated by the resource amount determination unit.

11. The information processing apparatus according to claim 9, wherein the resource amount determination unit is further configured to determine a larger resource amount as the required resource amount as an average of the observed value becomes larger.

12. The information processing apparatus according to claim 9, wherein the resource amount determination unit is further configured to determine a larger resource amount as the required resource amount as a variation in the value becomes larger.

13. The information processing apparatus according to claim 9,
wherein the specific state is a state indicating that a health condition of the object, which is the crop to be grown in the agricultural field, is impaired, and
wherein the resource amount determination unit is further configured to determine a larger resource amount as the required resource amount as a spatial variation in the observation data indicating the specific state becomes larger.

14. The information processing apparatus according to claim 8, wherein the output control unit is further configured to control the required resource amount determined for each task by the resource amount determination unit to be displayed in such a manner that the required resource amount is superimposed on a section in which each of a plurality of tasks is executed on the map in a case where task designation information for designating the plurality of tasks is received by the reception unit.

15. The information processing apparatus according to claim 14,
wherein the resource amount determination unit is further configured to determine a required resource amount for each of the plurality of tasks, and
wherein the one or more processors further function as an adjustment unit configured to adjust, based on an upper limit resource amount set in advance, the required resource amount determined by the resource amount determination unit.

16. The information processing apparatus according to claim 15, wherein the adjustment unit is further configured to reduce a required resource amount for at least one task in a case where a total value of the required resource amount determined by the resource amount determination unit is greater than the upper limit resource amount.

17. The information processing apparatus according to claim 15, wherein the adjustment unit is further configured to increase a required resource amount determined by the resource amount determination unit for at least one task in a case where a total value of the required resource amount determined by the resource amount determination unit is smaller than the upper limit resource amount.

18. The information processing apparatus according to claim 1, wherein the required resource amount is the number of workers who execute the task.

19. An information processing method comprising:
determining a required resource amount for executing a task to be executed in at least a partial section of an agricultural field in which a crop is grown based on a size of the section in which the task is executed and a state of an object on which the task is executed; and
controlling the determined required resource amount to be displayed in association with the section in which the task is executed on a map representing the agricultural field displayed on a predetermined display unit.

20. A non-transitory computer-readable medium storing a program for causing a computer to perform a method comprising:
determining a required resource amount for executing a task to be executed in at least a partial section of an agricultural field in which a crop is grown based on a size of the section in which the task is executed and a state of an object on which the task is executed; and
controlling the determined required resource amount to be displayed in association with the section in which the task is executed on a map representing the agricultural field displayed on a predetermined display unit.
